(19) United States
(12) Patent Application Publication
(10) Pub. No.: US 2016/0162769 A1
(43) Pub. Date: Jun. 9, 2016

(54) A Contactless Smart Chip For Biometric Tracking

(71) Applicant: Kok Ann WONG, Singapore (SG)

(72) Inventor: Kok Ann WONG, Singapore (SG)

(21) Appl. No.: 14/905,964

(22) PCT Filed: Jul. 18, 2014
(86) PCT No.: PCT/SG2014/000341

§ 371 Date: Jan. 19, 2016

(30) Foreign Application Priority Data
Jul. 19, 2013 (SG) 201305534-8

(51) Int. Cl. G06K 19/07; H04L 9/30; G06F 19/00; G06K 19/02; G06K 19/077

(52) U.S. Cl. CPC G06K 19/0723; G06K 19/02; G06K 19/07773; G06K 19/07762; G06K 19/07722; G06K 19/07728; G06F 19/322; H04L 9/30

(57) ABSTRACT

The present invention provide a wearable device for biometric tracking. The wearable device comprises a contactless smart chip module having an antenna connected thereto, the contactless smart chip module is adapted for storing personal information in a secured manner; a fibre glass substrate for encapsulating the contactless smart chip and the antenna therein; a protective shield surrounding at least a portion of the fibre glass substrate to provide a resistant finish. A system for entering the information and a method thereof are also provided.

### FIELD OF THE INVENTION

The present invention relates to a wearable device, system and method for biometric tracking through/using a contactless smart chip module and the system adapted for carrying out the same.

### BACKGROUND

Various wearable tagging devices have been developed for storing and processing personal information and being used for tracking purposes. US patent publication number US 2008/0094228A1 discloses a system for monitoring patient through RFID tag. The RFID tag is adapted to store the relevant information to suit the implementation, so that the relevant personnel can retrieve the information easily.

The RFID, tags are capable of storing small amount of information and the stored information can be retrieved by the processing module/device wirelessly. Nowadays, the RFID tags have been widely used especially in the medication since details of information such as blood type or inoculations historical can be easily track by medical personnel.

However, the RFID tags have minimal security protection and not applicable for storage for biometrics.

### SUMMARY

In one aspect of the present invention, a system for biometric tracking based on contactless smart chip module is provided. The system comprises of a data preparation module, an issuance module, a scheduler module and a security module. The data preparation module is used for centralized and secure a data dispatch point, wherein the said data preparation module stores a system certificate and private key. The issuance module is used to Personalized Batch Card whereas the scheduler module is to ensure a smooth process flow. Moreover, the security module is used for high performance security.

Preferably, the data preparation module is linked to the security module in order to get the high performance security operations. The Personalized Batch Card hold the master key to lock the blank card.

In another aspect of the present invention, a wearable device for biometric tracking with embedded of contactless smart chip module in the device is provided. The device comprises a contactless smart chip module having an antenna connected thereto. The contactless smart chip and the antenna are encapsulated by a fibre glass substrate while at least the portion of the fibre glass substrate is protected by a metal shield surrounding the fibre glass for a resistant finish.

In another aspect of the present invention, a method for biometric tracking based on the contactless smart chip module is provided. The method comprises creating a file lock with transport key, transporting the transport key from the file server, adding a digital signature with a secret key, encrypting data with diversified key, verifying with public key, wherein a key component of the digital signature is enrolled by capturing a photo and fingerprint, wherein the digital signature is personalized by pass printing and chip encoding, wherein the digital signature is issuance by bio-data and fingerprint verification.

### BRIEF DESCRIPTION OF DRAWINGS

Preferred embodiments according to the present invention will now be described with reference to the figures accompanied herein, in which like reference numerals denote like elements;

FIG. 1 illustrates a wearable tagging device 100 in accordance with one embodiment of the present invention;

FIG. 2 illustrates a block diagram of the layout of the secured contactless chip of FIG. 1 in accordance with one embodiment of the present invention;

FIG. 3 illustrates a key management lifecycle of the tagging device in accordance with one embodiment of the present invention;

FIG. 4 illustrates an enrolment process in accordance with one embodiment of the present invention; and

FIG. 5 illustrates a tag issuance diagram in accordance with one embodiment of the present invention.

### DETAILED DESCRIPTION

Embodiments of the present invention shall now be described in detail, with reference to the attached drawings. It is to be understood that no limitation of the scope of the invention is thereby intended, such alterations and further modifications in the illustrated device, and such further applications of the principles of the invention as illustrated therein being contemplated as would normally occur to one skilled in the art to which the invention relates.

The present invention provides a secured, open standard biometric access system comprising a wearable tagging device. The wearable tagging device is adapted for storing personal information of the holder, such as identity, medical history and others, in a secured manner. Preferably, the wearable tagging device is compact in size for easy carrying by holder, and the information stored therein can be easily retrieve through the authorized reader. In the present invention, it is preferred that the wearable tagging device is made in a form of pendant for wearing as a necklace.

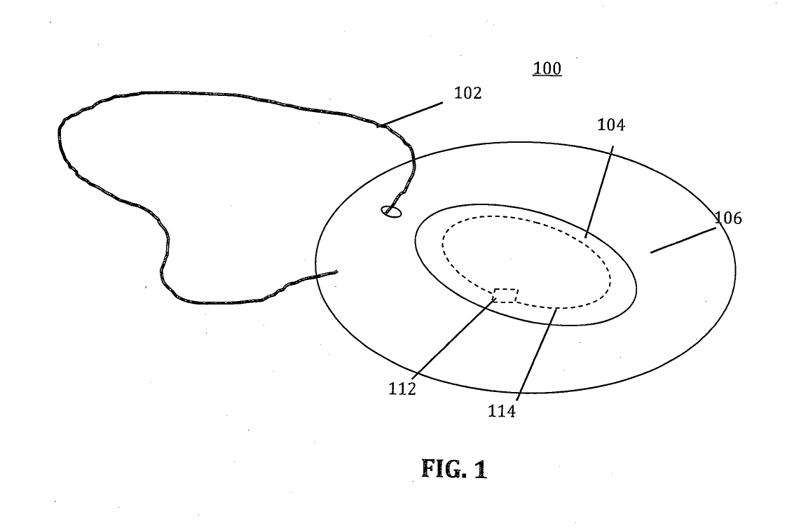

FIG. 1 illustrates a wearable tagging device 100 in accordance with one embodiment of the present invention. Typically, the wearable tagging device 100 is adapted for carrying with personnels who perform their duties in the field. These tagging device 100 is particularly useful for identifying the carriers' entities and allowing the authorized reader to identify if the carrier of a specific tagging device is the authentic owner of the tagging device. In particulars, it provides securities features that is able to securely store the required information therein. The securities features is able to prevent the tagging device to be cloned or duplicated or forged without authorization. The information stored therein may include personal particulars, the carrier's biometric information, as well as the person's medical related information or histories, which include inoculation histories.

The wearable tagging device 100 has a chain 102 attached to the wearable tagging device 100. The chain 102 can be any type and form of chain suitable for hanging the wearable device 100 on any person. Example of the chain 102 is a ball chain, although any type of chain is also possible.

Still referring to FIG. 1, the wearable tagging device 100 comprises a core chip 104 and a protective shield 106. As shown, the wearable tagging device 100 is adapted in a generally flat, oval shape. It is understood that many other shapes are also possible. The protective shield 106 is made up of corrosion-resistant material fabricated as a ring wrapping the core chip 104. The protective shield can be made up of any metallic or alloy material, such as aluminium, MONEL®, stainless-steel or the like. The protective shield 106 may have some limited identification information printed on its disposed surface thereon. The core chip 104 is provided to embedded components therein. It may be made by fibre glass, silicon or any other suitable material. The components embedded therein comprises a secured contactless chip 112 and an antenna 114. The secured contactless chip 112 is electrically connected to the antenna 114 and operationally in communication with external device, such as chip reader (now shown) through the antenna 114. The secured contactless chip 112 is adapted to stored personal information in a secured manner. When the secured contactless chip 112 is in close proximity with a compatible chip reader, the chip reader extracts the information stored within the chip through the antenna 114.

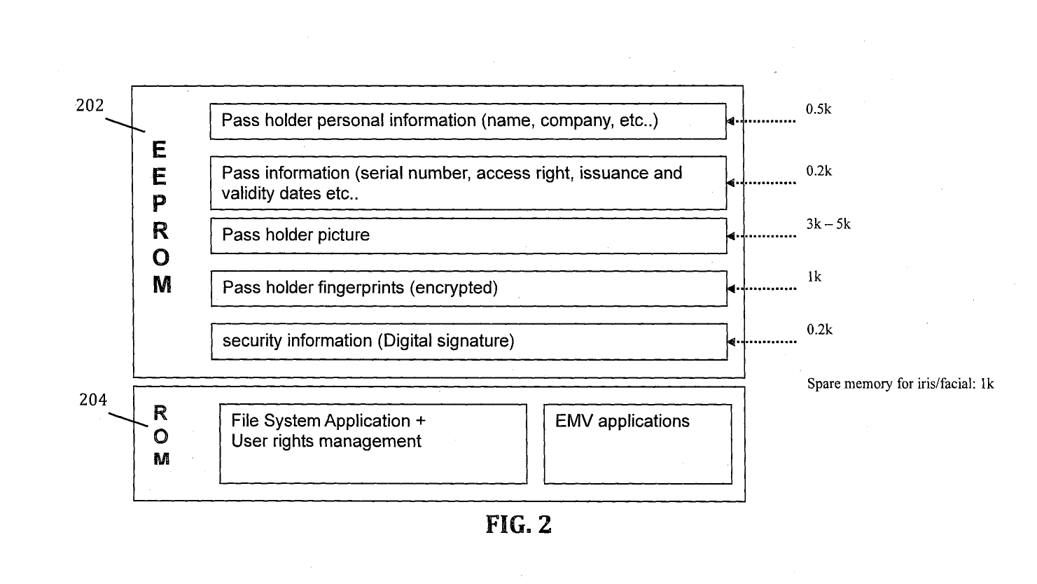

FIG. 2 illustrates a block diagram of the layout of the secured contactless chip 112 of FIG. 1 in accordance with one embodiment of the present invention. The data is stored on the chip in a ISO flexible file system. Various file systems are available such as ICAO LDS. The secured contactless chip 112 comprises a EEPROM 202 and a ROM 204. The EEPROM 202 may reserved about 0.5K Bytes for personal information of the holder, such as name, company's name and etc. About 0.2K Bytes may be reserved for identity of the secured contactless chip 112 such as serial number, access right, validity dates and etc. About 3K-5K Bytes may be reserved for holder picture in digital data form. About 1K Bytes may be reserved for the holder's biometric data such as finger print, etc., and about 0.2K Bytes may be reserved for security information such as digital signature. Preferably, the secured contactless chip shall be at least CC EAL4+ certified. It may also be FIPS 140 based chip, such as FIPS 140-2 Level 3 chip. The EEPROM 202 may further provide some spare memory, when necessary. The ROM 204 stored the required applications therein, such as file system application and user right manager, and EMC applications, or other e-pass applications. The applications may be Java applications supporting EAC (Extended Access Control) similar to that defined in the International Civil Aviation Organisation (ICOA) standard.

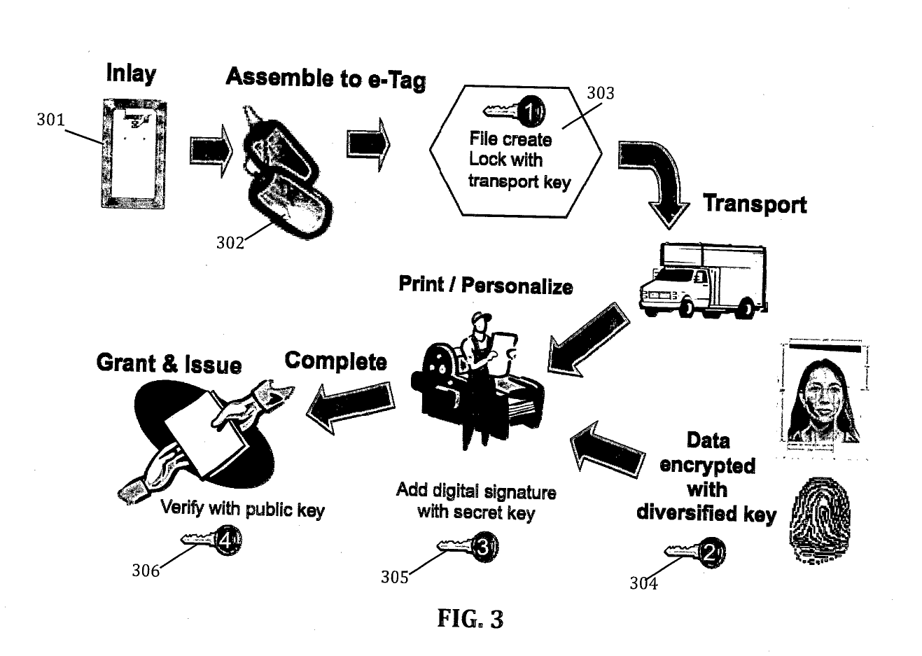

FIG. 3 illustrates a key management lifecycle of the tagging device in accordance with one embodiment of the present invention. The process starts with fabricating an inlay 301 of secure digital chip. The secure digital chip can be a contactless smart chip or the like. Once it is fabricated, it is being assembled into a e-Tag device 302. The e-Tag device 302 is fabricated as the wearable tagging device 100 for encasing the inlay 301 therein. The inlay 301 is fabricated with the secure digital chip with a file lock having a transport key 303 before actual informations is being embedded therein. The e-Tag will then be delivered and distributed to the on-site authority for granting and issuing the e-Tag to the carrier. The on-site authority inputs the relevant information into each e-Tag. The information are stored on the e-Tag encrypted with diversified key 304. The information may include the holder's picture(s), thumbprint, etc. which are enrolled earlier. Once the encrypted information of the carrier is stored on the respective e-Tag, the e-Tag may further engrave or print with the visible information on the e-Tag. Over at the on-site authority, the informations are also encrypted with a digital signature with a secret key 305 to protect the information stored therein. Once the e-Tag is granted and issued, they can be verified through a public key 306 with the authorized reader. The reader can be a Secure Access Module (SAM) based reader for reading the e-Tag.

TABLE 1 examplifies personal data which may be adapted on the e-Tag:

| | | | | | |
|---|---|---|---|---|---|
| Title | Title or salutation | C | 6 | O | ‘5F 14’ |
| Mailing_address | Correspondence or | C | 69 | O | ‘DF 21’ |
| | contact address | | | | |
| Telephone_no | Telephone number | C | 13 | O | ‘5F 12’ |
| Email_address | Email address | C | 50 | O | ‘DF 22’ |
| Religion | Religion | C | 15 | O | ‘DF 23’ |
| Nok | Name of next of kin | C | 66 | O | ‘DF 26’ |
| Nok_address | Address of next of kin | C | 69 | O | ‘DF 27’ |
| Drug_allergy | Drug allergy | C | 2 | O | ‘DF 24’ |
| Issuer level | Issuer level | C | 1 | O | ‘DF 28’ |
| Ns_eligibility | Eligibility for ns | C | 2 | O | ‘DF 29’ |
| Service_status | Civilian status or | C | 1 | O | ‘DF 2A’ |
| | uniformed status | | | | |
| | or both | | | | |
| Civilian_salutation | Civilian salutation | C | 6 | O | ‘DF 2B’ |
| Civilian_organisation | Civilian organisation | C | 16 | O | ‘DF 2C’ |
| Civilian_sub_or- | Civilian sub- | C | 20 | O | ‘DF |
| ganisation | organisation | | | | |

TABLE 2 examplifies further personal data which may also be adapted on the e-Tag:

| | | | Size | | | |
|---|---|---|---|---|---|---|
| Item name | Short description | Type | (bytes) | Req | TAG | Remarks |
| UIN | Unique identification | C | 9 | M | ‘5F 10’ | For example: |
| | number | | | | | NRIC, FIN, staff |
| | | | | | | ID |
| Name | Full name | C | 66 | M | ‘5F 0E’ | |
| Gender | Gender | C | 1 | M | ‘5F 35’ | “M” or “F” |
| Race | Race or ethnic group | C | 16 | M | ‘DF 1F’ | |
| Date_of_birth | Date of birth | C | 8 | M | ‘5F 2B’ | YYYYMMDD |
| | | | | | | format |
| Country_of_birth | Country of birth | C | 20 | M | ‘5F 11’ | |
| Citizenship | Citizenship | C | 2 | M | ‘5F 2C’ | ISO 3166 (alpha- |
| | | | | | | 2) |
| Address_registered | Address as in nric | C | 69 | M | ‘5F 42’ | |
| Date_issue | Date of issue | C | 8 | M | ‘5F 26’ | YYYYMMDD |
| | | | | | | format |
| Date_expiry | Date of expiry | C | 8 | M | ‘59’ | YYYYMMDD |
| | | | | | | format |
| Date_last_update | Date of last update | C | 8 | M | ‘DF 25’ | YYYYMMDD |
| | | | | | | format |
| Blood_group | Blood grouping | C | 3 | O | ‘DF 20’ | |
| Other_name | Alias or additional name | C | 66 | O | ‘5F 0F’ | |
| Profession | Profession or occupation | C | 20 | O | ‘5F 13’ | |

In an alternate embodiment, the secure digital chip may adopt a security standard similar to that adapted on e-Passport specification defined under International Civil Aviation Organisation (ICAO) or the like. It is also possible that other standard or protocols can also be adapted for the current wearable tagging device.

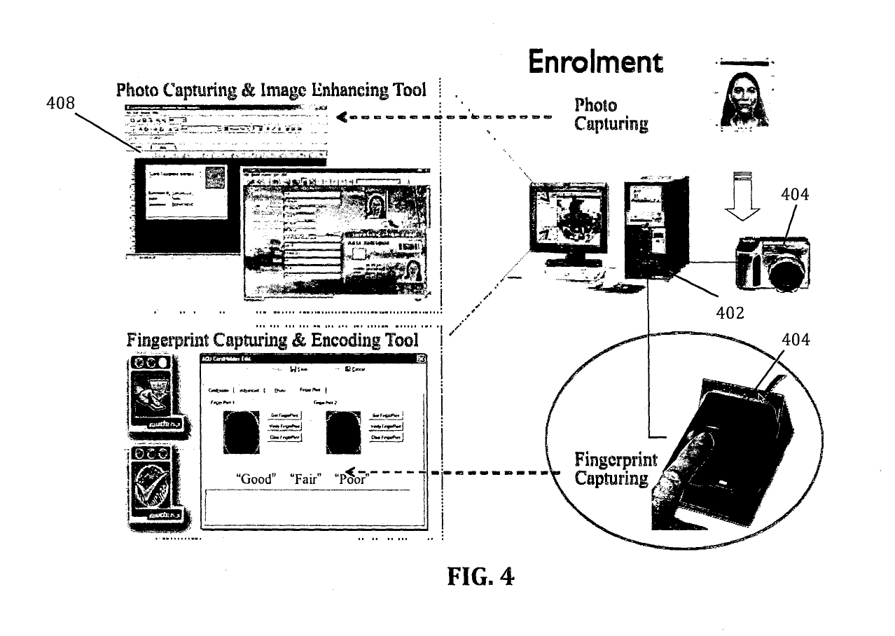

FIG. 4 illustrates an enrolment process in accordance with one embodiment of the present invention. The enrolment process requires an enrolment station 402 which has an imaging device 404 and a biometric reader 406. The enrolment station 402 can be any workstation or personal computer with an enrolment application 408 installed. The imaging device 404 can be any digital camera and the biometric reader can be a commercially available fingerprint reader for capturing fingerprint. If other biometric information is required, an appropriate biometric reader or scanner can be utilised. The enrolment application deployed on the enrolment station 402 may adapt known imaging tools to enhance the image captured through the imaging device 404. Similarly, the fingerprint capturing tool can be used to capture a desirably good quality image of the fingerprint and the biometric information shall be captured and encoded for storing on the chip.

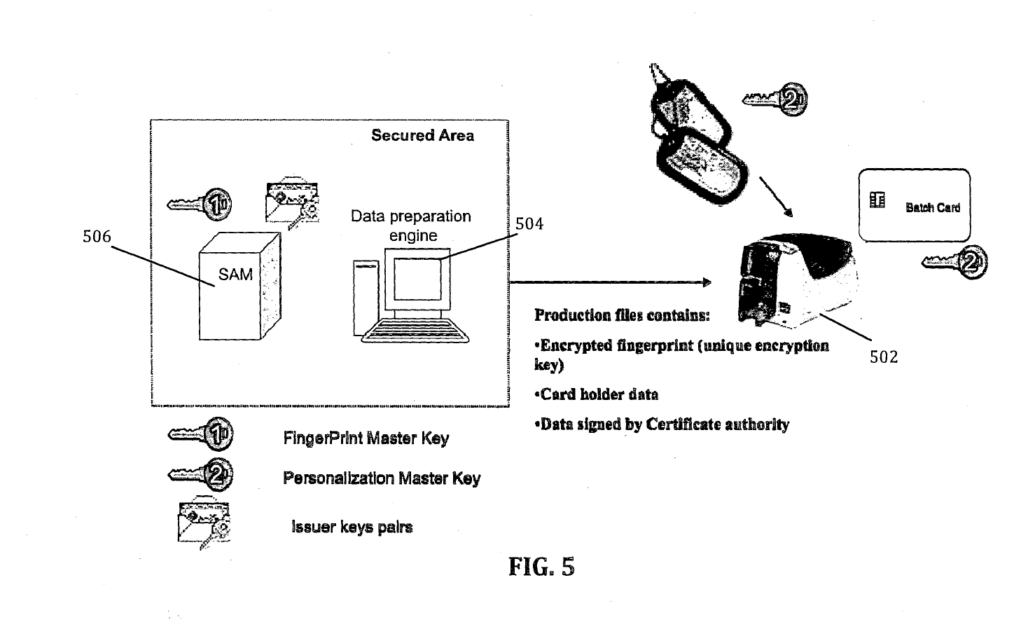

FIG. 5 illustrates a tag issuance diagram in accordance with one embodiment of the present invention. The tag issuance is provided with a tag writer 502 to write the required information into the wearable tagging device. Preferably, the data is written into the device wirelessly. The tag writer 502 includes a data preparation engine 504 and a SAM module 506 for operationally acquiring the required information from the on-site authority, preparing the data which include encryption with unique encryption key, and writing the same onto the chip of the wearable tagging device with a fingerprint master key and an issuer keys pair. The data is also written onto the device with a personalised master key. The data will be signed by a certificate authority.

One will appreciate that the wearable tagging device is capable to deploy other applications thereto. It can be used for any applications that an ordinary smart card can be used for, such as door access, payment application where ID is required, and etc.

While specific embodiments have been described and illustrated, it is understood that many changes, modifications, variations, and combinations thereof could be made to the present invention without departing from the scope of the invention.

1. A wearable device for biometric tracking, comprising:
a contactless smart chip module having an antenna connected thereto, the contactless smart chip module is adapted for storing personal information in a secured manner;
a fibre glass substrate for encapsulating the contactless smart chip and the antenna therein;
a protective shield surrounding at least a portion of the fibre glass substrate to provide a resistant finish.

2. The wearable device according to claim 1, wherein the personal information includes personal medical histories.

3. The wearable device according to claim 1, wherein the protective shield is made up in metal or alloy.

4. The wearable device according to claim 3, wherein the protective shield is made up of a corrosion-resistant material.

5. The wearable device according to claim 1, wherein the contactless smart chip secured the data stored therein base on an International Civil Aviation Organization (ICOA) standard.

6. The wearable device according to claim 1, wherein the contactless smart chip comprises Java applications that support Extended Access Control (EAC).

7. The wearable device according to claim 1, wherein the wearable device is fabricate in a dog tag form having a chain attached thereto.

8. A system for biometric tracking based on contactless smart chip module, comprising:
a data preparation module for centralized and secure a data dispatch point, wherein the said data preparation module stores a system certificate and private key;
an issuance module used a Personalized Batch Card;
a scheduler module to ensure smooth process flow;
a security module for high performance security wherein the said data preparation module is linked to the said security module;
wherein the Personalized Batch Card hold the master key to unlock the blank card.

9. A method for biometric tracking based on contactless smart chip module encapsulated, comprising:
creating a file lock with transport key;
encrypting data with diversified key;
adding a digital signature with a secret key;
verifying with public key;
wherein a key component of the digital signature is enrolled by capturing a photo and fingerprint;
the digital signature is personalized by pass printing and chip encoding;
the digital signature is issuance by bio-data and fingerprint verification.
